(19) United States
(12) Patent Application Publication
(10) Pub. No.: US 2004/0110537 A1
(43) Pub. Date: Jun. 10, 2004

(54) Method for improving a channel estimate in a radiocommunication system

(76) Inventor: Martin Haardt, Plane (DE)

Correspondence Address: STAAS & HALSEY LLP, SUITE 700, 1201 NEW YORK AVENUE, N.W., WASHINGTON, DC, 20005, US

(21) Appl. No.: 10/399,107

(22) PCT Filed: Oct. 12, 2001
(86) PCT No.: PCT/DE01/03922

(30) Foreign Application Priority Data
Oct. 16, 2000 (DE) 10051144.9

(51) Int. Cl. H04M 1/00; H04B 1/38

(52) U.S. Cl. 455/562.1; 455/561

(57) ABSTRACT

The invention relates to a method for improving a channel estimate of a radio signal which is transmitted in a radiocommunications system that operates with an adaptive antenna comprising a plurality M of antenna elements. Said method comprises the following steps: forming a spatial covariance matrix using a starting channel estimate, this starting channel estimate being in the form of a vector in an M-dimensional vector space; determining a number Ln of eigenvectors of the spatial covariance matrix which is smaller than the plurality M of the antenna elements; calculating a projection of the starting channel estimate onto the sub-space spanned by the Ln eigenvectors; replacing the starting channel estimate with the projection.

The invention relates to a method for improving the channel estimate in a radiocommunications system operating with an adaptive antenna comprising a plurality of M antenna elements.

In radiocommunications systems messages (for example voice, picture information or other data) are transmitted using electromagnetic waves via a radio interface between transmitting and receiving radio stations (Base Station or Mobile Station). The electromagnetic waves are radiated here using carrier frequencies lying within the frequency band provided for the relevant system. With GSM (Global System for Mobile Communication) the carrier frequencies lie in the range of 900, 1800 or 1900 MHz. For future mobile radio networks with CDMA or TD/CDMA transmission method over the radio interface, for example the UMTS (Universal Mobile Telecommunication System) or other 3rd-generation systems frequencies in the band of around 2000 MHz are envisioned.

When signals are propagated in a propagation medium they are susceptible to faults caused by interference. Bending and reflection cases signal components to pass along different propagation paths and to be overlaid at the receiver which leads to extinction effects. Furthermore, with several signal sources the result is overlaying of these signals. Frequency Division Multiplex (FDMA), Time Division Multiplex (TDMA) or a method known as Code Division Multiplex (CDMA) are used to distinguish between the signal sources and thereby to evaluate the signals.

If the receiver has a multi-element antenna, the contributions of the various propagation paths at the receiver can be distinguished by the phase positions at which they arrive at the individual elements of the antenna. The phase difference between the signal contributions at the individual antenna elements are characteristic for the direction of origin of the propagation path. By array steering, i.e. by scalar multiplication of the contributions of the individual antenna elements with a complex weighting factor or array steering factor, the contributions of a propagation path at the individual antenna elements can be constructively overlaid to form a receive signal. The constructive overlaying is synonymous with a selectively boosted sensitivity of the adaptive antenna for signals arriving for the direction of the propagation path concerned.

Being able to align the sensitivity of the adaptive antenna selectively to the direction of arrival of a radio signal requires knowledge of the direction of arrival of the radio signal and of the selective array steering vector for this direction.

If in the opposite direction the transmitter has the multi-element antenna and the receiver has a single-element antenna, the receive signal at the receiver is composed of components of the different propagation paths arriving at the receiver with different time delays in each case, in which case the components of each transmission path in their turn consist of contributions of the elements of the transmitter antenna which overlay each other with the characteristic phase difference for the propagation direction of the transmission path. These phase differences can be recorded for the receiver using training sequences that are periodically radiated by the transmitter, in which case each antenna element radiates a characteristic sequence that is orthogonal to the training sequences of the other elements. Here too the sensitivity of the receiver can be selectively increased for the signal transmitted over a specific propagation path, by defining, as specified above, a complex array steering vector, and by multiplying the signal delivered by an antenna of the receiver by a coefficient of the array steering vector and adding up the products thus obtained.

The decisive factor in the extent of improvement to the reception quality that can be obtained in this way is the accuracy with which the steering array vector can be specified. This means that as accurate as possible a channel estimate of the transmission paths that dominate the receive signal are needed.

This estimation is based on the radio signals measured by the receiver. On the one hand there is interference to these radio signals from rapid phase and amplitude fluctuations on the transmission paths, on the other hand they are overlaid with signals of other transmitters, that—in particular in the case of a CDMA-radio communications system—cannot always be separated without errors from the relevant radio signal.

The object of the invention is to create a method that allows an improvement of any prespecified starting channel estimate, whereby the way in which this starting channel estimate has been obtained is not relevant.

This object is achieved by the method with the characteristics of patent claim 1.

The starting point for the method for example is the knowledge from DE-A-198 03 188 A1 that the channel response words hₙ(t) of the propagation paths of a radio signal are given by eigenvectors of a spatial covariance matrix or a linear combination of these. The channel impulse response of an individual propagation path can be written as

hₙ(t)=a(μₙ)αₙ(t),

in which case a(μₙ) is the array steering vector for directed transmission to (or directed receiving from) the relevant transmission path and αₙ(t) is the corresponding complex amplitude. This array steering vector has M Components, where M is the number of the antenna elements. Whereas the array steering vector a(μₙ) is constant depending on a relative movement between transmitter and receiver over relatively long periods of time, complex amplitude αₙ(t) is subject to fast fading and is undergoes rapid changes.

if a plurality Lₙ of transmission paths exhibit an identical delay time, the spatial impulse word of a tap of the receive signal identified by this delay time has the form

$${h}_{n} ( t ) = {\sum }_{i = 1}^{{N}_{1}} α ( {μ}_{{n}_{i}} ) {α}_{{n}_{l}} ( t ) .$$

The pulse response hₙ(t) is thus a vector in an Lₙ-dimensional sub-space of the M-dimensional complex count space that is spanned by array steering vectors

If transmission were free from interference and the array steering vectors known precisely, the impulse response determined for a signal received would have to be a vector in the sub-space. In practice both conditions are not met; the receiver only knows the array steering vector approximately and there is interference. If however determining impulse response delivers a vector hₙ(t), this can be broken down into two perpendicular vectors hₙ^{p}(t) and hₙ^{s}(t), of which one hₙ^{p}(t) lies in the sub-space and the other hₙ^{s}(t) is perpendicular to the sub-space (as shown by the superscripted indices p for parallel and s for vertical). In such a case it is justified to assume that hₙ^{p}(t) corresponds to the true signal and hₙ^{s}(t) is attributable to interference in reception by other transmitters, and that therefore hₙ^{p}(t) is a better estimate of the impulse response than hₙ(t).

The dimension Lₙ must necessarily be smaller than the dimension M, since otherwise hₙ^{p}(t)and hₙ(t)would be identical. How large Lₙ is in practice can be determined depending on a concrete application environment of the method by simulation or experiment in such a way that the largest possible improvement of the estimate is achieved. Methods to estimate Lₙ are described in an article by M. Wax and T. Kailath, “Detection of Signals by Information theoretic criteria”, IEEE Trans. Acoustics, Speech and Signal Processing, Volume ASSP-33, P. 387-392, 1985.

Exemplary embodiments are the subject of dependent claims.

The covariance matrix, from which the steering array vectors are obtainable as eigenvectors, is preferably averaged over a longer period of time that can lie in a range of a few multiples of 10 seconds up to minutes, in order to average out the influence of rapid fluctuations of complex amplitude α(t).

Since the propagation paths that the radio signal between transmitter and receiver takes can be different for each delay time, i.e. for each tap of the received signal, it makes sense to perform the method described above for each tap individually and independently of the others.

If when the radio signal is propagated by an adaptive antenna a number of eigenvectors of the covariance matrix are used as array steering vectors, whether a linear combination of a number of eigenvectors space used or whether a different eigenvector is used in each case as array steering vector in consecutive time slots of the radio signal, it makes sense to have a method in which all the starting channel estimates for each tap of the received a signal are present individually, but in which the covariance matrixes obtained from these starting channel estimates are added up before the eigenvectors of the matrix thus obtained are determined and the projections to the sub-space spanned by these eigenvectors are defined. This measure guarantees specifically that on sending no two steering array vectors are used that are partly overlapping and therefore do not correspond to completely decorrelated propagation paths.

Exemplary embodiments are explained in more detail below on the basis of the drawing. The figures show:

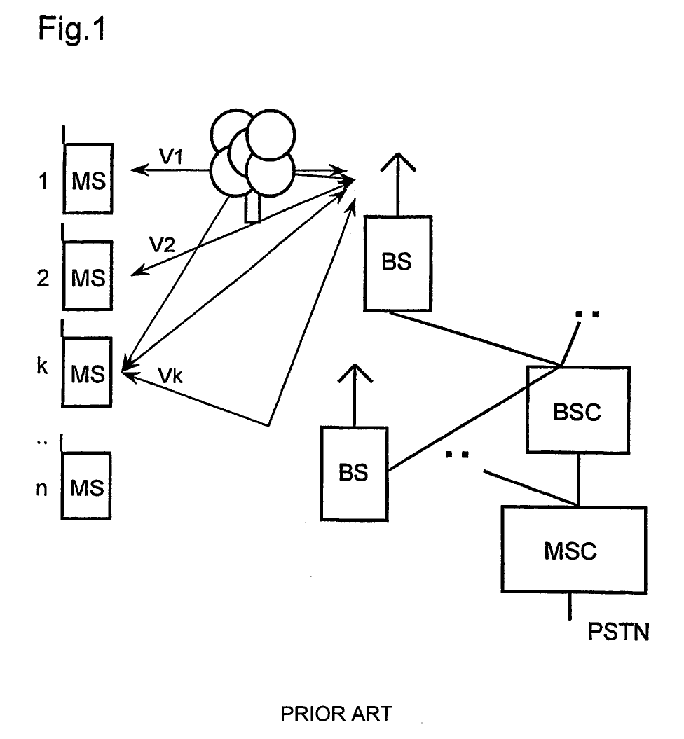

FIG. 1 a radiocommunications system in which the method in accordance with the invention can be used;

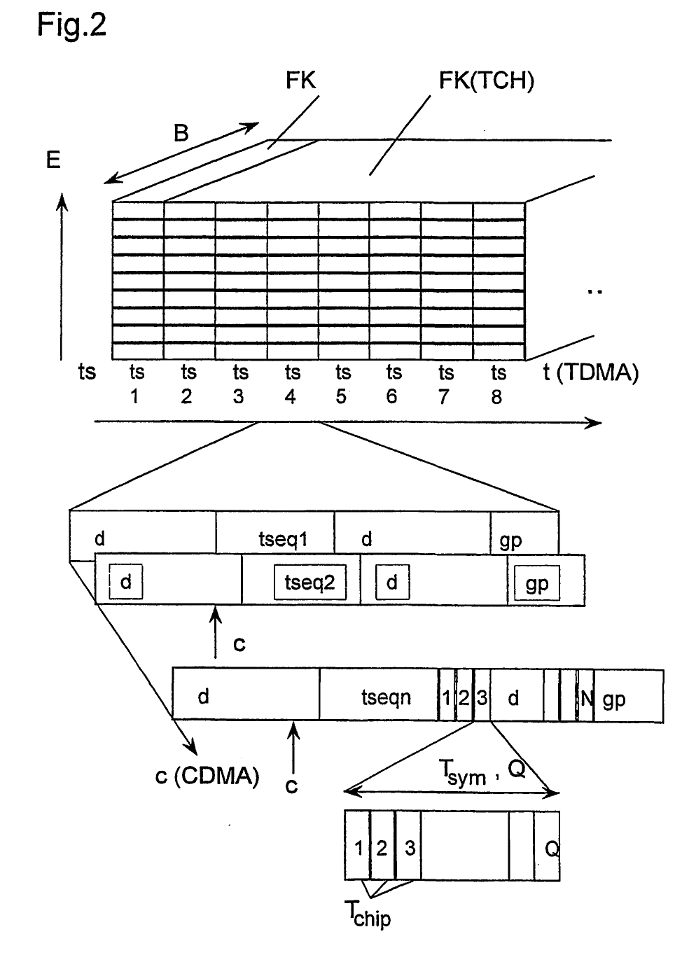

FIG. 2 a schematic representation of the frame structure of radio transmission,

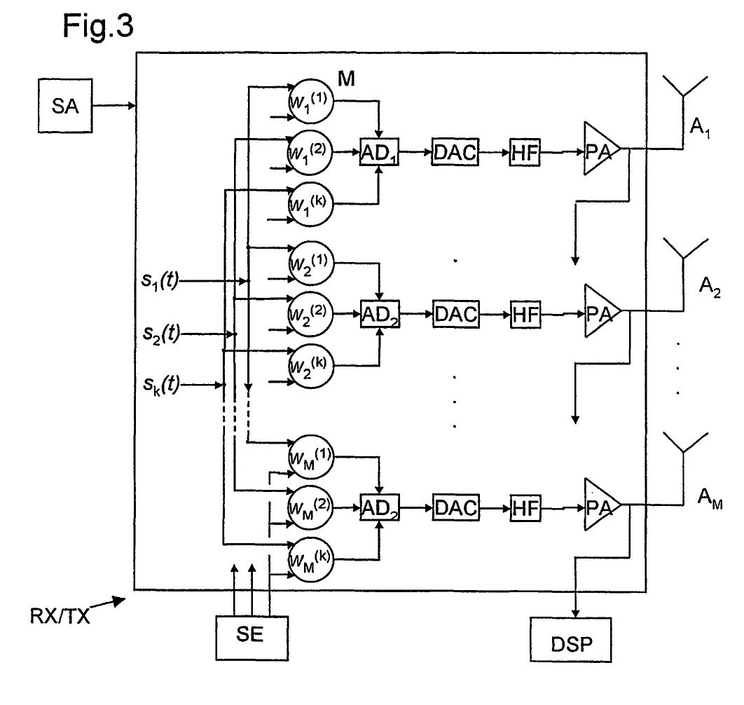

FIG. 3 a block schematic of the Base Station;

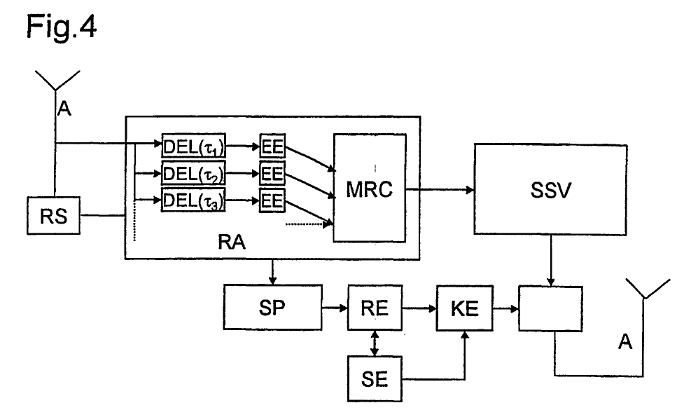

FIG. 4 a block schematic of the Mobile Station;

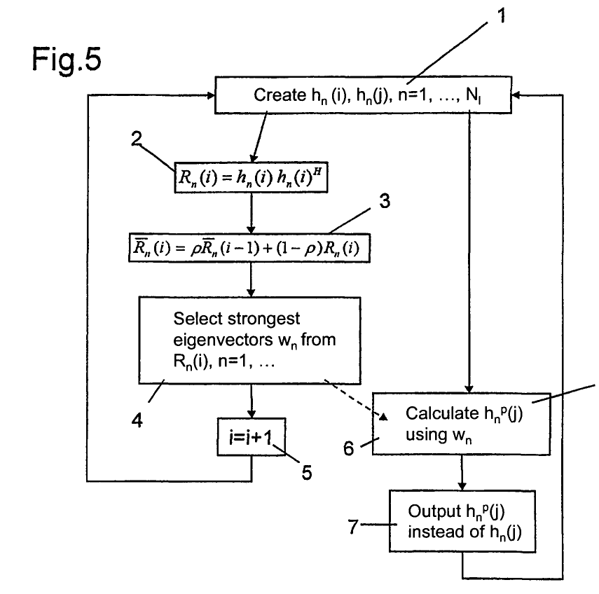

FIG. 5 a flowchart of the method in accordance with the invention for improving a channel estimate in accordance with a first embodiment; and

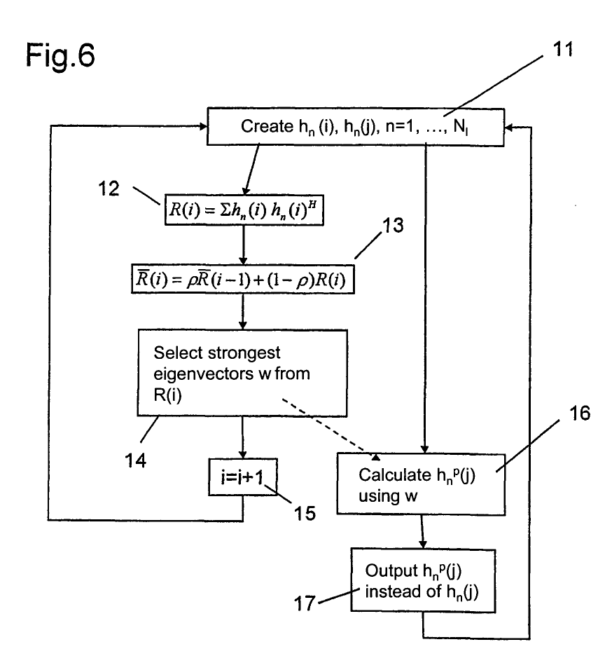

FIG. 6 a flowchart of the method in accordance with the invention in accordance with a first embodiment.

The radio communications system shown in FIG. 1 corresponds in its structure to a known GSM mobile radio network which consists of a large number of Mobile Switching Centers MSC that are internetworked or establish access to a Public Switched Telephone Network PSTN. Furthermore these Mobile Switching Centers MSC are each linked to at least one Base Station Controller BSC. Each Base Station Controller BSC in its turn allows a connection to at least one Base Station BS.

This type of Base Station BS can set up a messaging connection to Mobile Stations MS via a radio interface.

FIG. 1 shows typical connections V1, V2, Vk for transmission of payload information and signaling information between Mobile Stations MS1, MS2, MSk, MSn and a Base Station BS. An Operations and Maintenance Center OMC implements control and maintenance functions for the mobile radio networks or for parts thereof. The functionality of this structure can be transferred to other radiocommunications systems in which the invention can be used, in particular for subscriber access networks with wireless subscriber access.

The frame structure of the radio transmission can be seen from FIG. 2. In accordance with a TDMA component a broadband frequency range is divided up, typically bandwidth B=1.2 MHz, into a number of time slots ts, for example eight time slots ts1 through ts8 are provided. Each time slot ts within the frequency range B forms a frequency channel FK. Within the frequency channels TCH that are intended solely for payload data transmission, information from a number of connections is transmitted in radio blocks.

These radio blocks for payload data transmission consist of sections with data d, in which sections with training sequences known to the Receive side tseg1 to tsegn are embedded. The data is spread for individual connections with a detailed structure, a subscriber code c, so that on the receive side for example n connections can be separated by this CDMA component.

The spreading of individual symbols of data d causes Q chips of duration T_{chip} to be transmitted within symbol duration T_{sym}. The Q chips form the connection-individual subscriber code c in this case.

Furthermore, within the time slot ts there is provision for a guard period gp to compensate for differing signal delay times of the connections.

Within a broadband frequency range B the consecutive time slots ts are divided up in accordance with a frame structure. This means that eight time slots ts are combined into one frame, in which case for example a time slot ts4 of the frame forms a frequency channel for signaling FK or a frequency channel TCH for payload data transmission, in which case the latter can be used repeatedly by a group of connections.

FIG. 3 shows a schematic of the structure of a Base Station BS. A signal creation device SA assembles the send signal intended for Mobile Station MSk into radio blocks and assigns it to a frequency channel TCH. A transmit/receive device TX/RX receives the transmit signal sₖ(t) from the signal creation device SA. The transmit/receive device TX/RX comprises a ray forming network in which the transmit signal sₖ(t) for the Mobile Station MSk is combined with transmit signals s₁(t), s₂(t), . . . that are intended for other Mobile Stations to which the same transmit frequency is assigned. The ray forming network comprises for each mobile signal and each antenna element a multiplier M that multiplies the transmit signal sₖ(t) by a component wₘ^{(k)} of an array steering vector w^{(k)} that is assigned to the receiving Mobile Station MSk. The starting signals of the multipliers M assigned to an antenna element Aₘ, m=1, . . . in each case are added up by an adder ADₘ, , m=1, 2, . . . , turned into analog signals by a digital-analog converter DAC, converted to the transmit frequency (HF) and amplified in a power amplifier PA before they reach antenna element A₁, . . . , A_{M}. a structure similar to the ray forming network described, that is not shown separately in the figure, is positioned between the antenna elements A₁, A₂, . . . , A_{M} and a digital signal processor DSP, to divide up the received mixture of uplink signals in the contributions to the individual Mobile Stations and direct these separately to the DSP.

A storage device SE contains a set of array steering vectors w^{(k,1)}, w^{(k,2)}, . . . , for each Mobile Station MSk from which the array steering vector w^{(k)} used by multipliers M is selected or—alternatively—linearly combined.

FIG. 4 shows schematically the structure of a Mobile Station MSk. The Mobile Station MSk comprises a single antenna A, that receives the downlink signal radiated from the Base Station BS. The receive signal converted into the baseband by A is directed to what is known as a Rake Searcher RS that serves to measure delay time differences from contributions of the downlink signal that have reached antenna A via different propagation paths. In other words the Rake Searcher RS defines the delay time differences between the different taps of the receive signal. The received signal is also present at a Rake Amplifier RA that comprises a plurality of rake fingers of which three are shown in the Figure and each of which features a delay element DEL and an despreader-descrambler EE. The Delay elements DEL delay the receive signal by a delay value τ₁, τ₂, τ₃ . . . delivered by the Rake-Searcher RS in each case . The despreaders-descramblers EE each deliver at their outputs a sequence of estimated symbols, whereby the results of the estimate can differ for the individual descramblers because of the differing phase slots of the downlink-signal for descrambling and despreading code in the individual fingers of the rake amplifier.

The sequences of symbols delivered by the despreaders-descramblers EE also contain the results of the estimate of training sequences tseq that a radiated by the Base Station, and that are quasi-orthogonal and characteristic for each antenna element of the base station. A signal processor SP is used to compare the results of the estimate of these training sequences with those symbols known by the Mobile Station, actually contained in the training sequences. On the basis of this comparison, the variably timed impulse response hₙ(t) of the transmission signal between Base Station BS and Mobile Station MSk can be determined for each individual finger or tap.

A Maximum Ratio Combiner MRC is also connected to the outputs of the despreaders-descramblers EE, which combines the individual estimated symbol sequences into a combined signal sequence with the best possible signal-to-noise ratio and delivers this to a speech signal processing unit SSV. The method of operation of this unit SSV that converts the received symbol sequence into a signal that is audible for the user or converts received tones into a transmit symbol sequence, has long been known and does not need to be described here.

The Channel impulse words hₙ(t)determined for example in accordance with a Gauβ-Markov or a maximum-likelihood estimation based on the training sequences tseg1 to tsegn and the received digital data symbols e are routed to the Maximum Ratio Combiner MRC for a combined detection. Furthermore the control device SE receives the channel impulse responses hₙ(t) and the received digital data symbols e for determining spatial covariance matrixes Rₓₓ for a kth connection Vk.

FIG. 5 shows the steps of a first embodiment of the method for improving the channel estimate on the basis of a flowchart. Step 1 of determining the channel impulse responses hₙ(i) is undertaken once in time slot i; i=0, 1, 2, . . . allocated to connection Vk and separately for each tap of the receive signal. If N is the number of the dominating taps of the receive signal, i.e. the number of taps that is strong enough for its evaluation to improve the certainty of the symbol estimate, a set of N channel impulse responses hₙ(t), n=1, . . . , N is thus created in each time slot i. These sets are designated as the starting channel estimate.

A temporary covariance matrix Rₙ(i) is obtained in step 2 from these Channel impulse responses by forming the product with the hermetically conjugated vector:

Rₙ(i)=hₙ(i)hₙ(i)^{H}, i=0, 1, 2, . . . (1)

Channel response words hₙ(i) fluctuate strongly since the rapidly changing complex amplitudes αₙ(t) enter into them fully. To make the estimate more independent of these fluctuations a timed averaging an averaging over a plurality of consecutive time slots is performed in step 3:

\overline{R}ₙ(i)=p\overline{R}ₙ(i−1)+(1−p)Rₙ(i), i=1, 2, . . . (2)

\overline{R}ₙ(0)=Rₙ(0)

In this case p represents a time constant of the flexible average value computation which is selected between 0 and 1.

The spatial channel estimates are subject to interference from other transmitters and additive noise; i.e. the measured vectors hₙ(i) are not always parallel to those of the—a priori unknown—actual impulse response. if the averaging is conducted over a number of time slots i, this generally leads to the M×M-Matrix \overline{R}ₙ(i) having the full rank M.

Each non-disappearing eigenvector of the averaged covariance matrix corresponds to a propagation path of the nth tap, with the signal amplitude on the transmission path being proportional to the own value assigned to the eigenvector. It is thus easily possible using an eigenvector and the own value analysis of the averaged covariance matrix \overline{R}ₙ(i) to find out those Lₙ transmission paths that make the greatest contribution to the nth tap of the receive signal (Step 4).

The value of the number Lₙ can be determined in different ways. A simple option is to specify a preset value that is the same for all taps. It would also be conceivable to select in each tap n as many eigenvectors wₙ, so that these occur for a specified percentage of the receive power of the tap concerned, in which case the number of own values to achieve this power can differ from one tap to another. A further option is to specify a percentage of the overall receive power and thus to consider as many eigenvectors wₙ regardless of which tap n they belong to, as is necessary to reach the percentage. It is also worthwhile to define the percentage to be reached dependent on the signal-to-noise ratio of the receive signal so that the power of the transmission paths that remain unconsidered is of the order of magnitude of the interference. Information theoretic criteria can also be included, such as those described in the article by M. Wax and T. Kailath that has already been quoted.

When Step 1 is repeated to create a new starting channel estimate hₙ(j) for a later time slot j>i, it can be assumed that this new starting channel estimate hₙ(j) is largely composed of the contributions of the dominating transmission paths and otherwise of interference and contributions from weaker transmission paths. The eigenvectors wₙ of the dominating transmission paths are known from the previous analysis of the averaged covariance matrix \overline{R}ₙ(i) (steps 3, 4). The contributions of the dominating transmission paths to channel estimate hₙ(j) must be parallel vectors to these eigenvectors wₙ, i.e. their sum lies in an Lₙ-dimensional sub-space spanned by the dominating eigenvectors wₙ. Shares of hₙ(j) that do not lie in the sub-space, i.e. that are perpendicular to all dominating eigenvectors, cannot refer back to a signal transmitted on this transmission path and are thus highly likely to be a fault.

To exclude these faults the projection of hₙ(j) to the sub-space spanned by the dominating eigenvectors wₙ is calculated in Step 6. Let U(n) now be the complex M×Lₙ matrix for which the columns are formed by the Lₙ dominating eigenvectors wₙ of the average covariance matrix \overline{R}ₙ(i) of the nth tap. The share hₙ^{p}(j) of hₙ(j) projected into the sub-space is then given by

$${h}_{n}^{p} ( j ) = {P}_{p} ( n ) {h}_{n} ( j ) = \underbrace{{( U ( n ) {U ( n )}^{H} )}^{- 1} {U ( n )}^{H} {h}_{n} ( j )}_{c} . \qquad ( 3 )$$

Projection operator Pₚ(n) is simplified here to U(n)U(n)^{H} if the columns of Uₙ are unitary.

The channel estimates hₙ^{p}(j) obtained by projection onto the sub-space represent the improved channel estimate which is output in Step 7.

This improved estimation can be used in particular for ray forming by the adaptive antenna of the Base Station BS from FIG. 1 in transmission to the Mobile Station MSk, as described in the German patent application with the reference number 10032426.6 dated Apr. 7, 2000 from the same applicant. They are also usable for the evaluation of a radio signal received by an adaptive antenna featuring a number of elements, as described in German patent application with the reference number 10032427.4, also dated Apr. 7, 2000, from same applicant, whereby in this case the devices used to determine the taps described with reference to FIG. 4, create their starting channel estimate and for improving this estimate are to be provided in a similar fashion at the Base Station.

When the method to control the ray forming on the downlink is used, the determination of the impulse responses hₙ(i) in FDD systems (Frequency Duplex Division, i.e. systems that use different frequencies on uplink and downlink) takes place mostly at the receiving Mobile Station MSk. The reason for this is that the complex amplitudes of a given transmission path depend on the carrier frequency, so that a measurement undertaken at the Base Station on the uplink signal does not allow any direct correlation to the impulse response in the downlink.

The eigenvectors obtained by the Mobile Station MSk from the averaged covariance matrix are transmitted to the Base Station BS at longer periods in accordance with their speed of change. in the interim Mobile Station MSk, as described in the named patent application 10032426.6, transmits designations of eigenvectors that the Base Station is to use as ray forming vectors when transmitting or relative array steering coefficients that specify to the Base Station BS the relative weight with which a specific eigenvector is to enter into a linear combination of eigenvectors used by the Base Station as ray forming vector.

To this end it makes sense if the Mobile Station calculates the coefficients cₗ, l=1, . . . Lₙ of vector h^{p}(i) in a co-ordinate system spanned by the dominating eigenvectors.

Such a vector c=(c₁, . . . c_{N}) is, as already indicated in equation (3), expressed by

(U(n)U(n)^{H})⁻¹U(n)^{H}hₙ(j)

The index of the largest value of vector c designates the eigenvector or the propagation path that makes the greatest contribution to the signal. It is thus sufficient for the Mobile Station to transmit this index within the context of a short-term feedback to the Base Station to have the latter send payload data in the following time slots to Mobile Station MSk using eigenvector as a ray forming vector. When the Base Station uses a linear combination of eigenvectors as ray forming vector, the composition of the linear combination can be optimized by transmitting the values of the coefficients of c.

The method presented above can also be generally applied to the use of spatial covariance matrixes that are averaged over all N dominating taps of the radio signal. The method modified in this way is shown as a flowchart in FIG. 6 in which the individual steps are designated with an identification letter that is greater by 10 than the same steps of the method in accordance with FIG. 5 in each case.

The impulse responses hₙ(i) in Step 11 are determined in the same way as specified above in Step 1. Equation (2) is replaced in this method by

$$\begin{matrix}\overline{R} ( i ) = p {\overline{R}}_{n} ( i - 1 ) + ( 1 - p ) {\sum }_{n = 1}^{N} {R}_{n} ( i ) , i = 1 , 2 , … \\ {\overline{R}}_{n} ( 0 ) = {\sum }_{n = 1}^{N} {R}_{n} ( 0 ) ,\end{matrix} \qquad ( 4 )$$

or, if the impulse responses hₙ(:i) are combined into an M×N matrix

H(i)=[h₁(i) h₂(i) . . . hₙ(i)]

\overline{R}(i)=p\overline{R}ₙ(i−1)+(1−p)H(1)H(i)^{H}, i=1, 2, . . . (4′)

i.e. in step 12 the covariance matrixes Rₙ(i) is determined in the same way as in step 2 for all taps and then added to R(i) and in step 13 by the averaged covariance matrix \overline{R}ₙ(i) is obtained by flexible averaging of R(i).

The dominant eigenvectors w of the averaged covariance matrix are determined as specified above for step 4, using averaged covariance matrix \overline{R}ₙ(i).

Here too the accuracy of a channel estimate can be greatly improved if the estimate hₙ(j) obtained for a time slot j is replaced in step 16 by a its projection hₙ^{p}(j) onto a sub-space spanned by the dominant eigenvectors.

The reason for undertaking this type of averaging across all taps is as follows:

The bandwidth available for transmitting ray forming information in the form of array steering vectors, their designations etc. from the Mobile Station to the Base Station is extremely limited. It is thus not possible to transmit more than a few dominating eigenvectors from the Mobile Station to the Base Station that will subsequently, whether by selection or by linear combination, be used for ray forming. Eigenvectors received for different signal delay times or different taps of the received signal can however go back largely on this same transmission paths, e.g. because the Mobile Station receives a signal radiated in a given direction and its reflected echo from an obstacle located behind the Mobile Station. These two contributions are not decorrelated, i.e. the probability that both fail simultaneously is higher than with signals that are propagated on completely different paths. It is thus desirable that the eigenvectors used by the Base station for ray forming do not correspond to such correlated transmission paths. This gives a simple way of ensuring that, when the eigenvectors are only determined on the basis of a single covariance matrix, since the orthogonality of the eigenvectors (in their M-dimensional vector space) forces no two eigenvectors to correspond to a same direction of radiation from the Base Station. The undesired use of eigenvectors corresponding to correlated transmission paths is therefore excluded.

In a TDD system in which the uplink and downlink frequency are the same, the impulse responses of the transmission paths are also the same in both directions. In a system of this type it is advantageous in equip the Base Station with the resources described above for the Mobile Station to determine the impulse responses and to determine the eigenvectors. On the one hand this allows use of simpler and thereby more cost-effective Mobile Stations, on the other hand there is no need to transmit to the Base Station information about the components of the eigenvectors and the designations of the eigenvectors selected for a short period and used by the Base Station for transmitting. The eigenvectors can be determined here in exactly the same way as specified above. Since however the Base Stations generally have more elaborate transmitters than the Mobile Stations and are in a position to compensate for even large delay time differences of different propagation paths than the receivers of the Mobile Stations, account should be taken here as an additional criterion in selecting the Lₙ eigenvectors to be determined, of the fact that the delay time differences between the propagation paths corresponding to these eigenvectors may not be greater than the maximum delay time difference for which the receivers of the Mobile Stations are in a position to compensate.

1. Method for improving a channel estimate of a radio signal which is transmitted in a radiocommunications system that operates with an adaptive antenna comprising a plurality M of antenna elements, with steps a) Forming a spatial covariance matrix using a starting channel estimate, with the starting channel estimate being in the form of a vector in an M-dimensional vector space;
b) Determining a number Lₙ of eigenvectors of the spatial covariance matrix which is smaller than the plurality M of the antenna elements;
c) Calculating a projection of the starting channel estimate onto the sub-space spanned by the Lₙ eigenvectors; d) Replacing the starting channel estimate with the projection.

2. Method in accordance with claim 1, characterized in that the formation of the spatial covariance matrix includes a timing averaging.

3. Method in accordance with claim 1 or 2, characterized in that it is used for the channel estimate or a radio signal received by the adaptive antenna.

4. Method in accordance with claim 1 or 2, characterized in that it is used for the channel estimate or a radio signal radiated by the adaptive antenna.

5. Method in accordance with one of the preceding claims, characterized in that the starting channel estimate is present individually for each of a plurality of taps of the radio signal, and that steps a to d are performed individually for each of these taps.

6. Method in accordance with one of the claims 1 to 4, characterized in that the starting channel estimate is present individually for each of a plurality of taps of the radio signal, and that step a is performed for each of these taps individually, that covariance matrixes thus obtained for each of the plurality of taps are added in order to form an averaged covariance matrix, and that steps b to d are performed on the averaged covariance matrix.

7. Method for improving a set of channel estimates of a radio signal which is transmitted in a radiocommunications system that operates with an adaptive antenna comprising a plurality M of antenna elements, with each starting channel estimate of the set being related to an individual tap of the radio signal, characterized in that the method is performed in accordance with one of the previous claims for each starting channel estimate of the set independently.

8. Method for improving a set of channel estimates of a radio signal which is transmitted in a radiocommunications system that operates with an adaptive antenna comprising a plurality M of antenna elements, with each starting channel estimate of the set being related to an individual tap of the radio signal, characterized in that step a) of the method is performed in accordance with one of claims 1 to 6 for each starting channel estimate of the set independently, that the covariance matrixes obtained are added and that steps b) to d) are performed on the covariance matrix obtained by addition.
